(19) United States
(12) Patent Application Publication
(10) Pub. No.: US 2024/0053024 A1
(43) Pub. Date: Feb. 15, 2024

(54) Photovoltaic Direct Current Hot Plate Cooking System

(71) Applicants: Barry Lynn Butler, Solana Beach, CA (US); Brett Louis Butler, Encinitas, CA (US)

(72) Inventors: Barry Lynn Butler, Solana Beach, CA (US); Brett Louis Butler, Encinitas, CA (US)

(21) Appl. No.: 17/819,632

(22) Filed: Aug. 14, 2022

(51) Int. Cl. F24C 7/08; H05B 1/02; H02S 10/20; H02J 3/38; H02J 7/35; H02J 7/00

(52) U.S. Cl. CPC F24C 7/082; H05B 1/0261; H02S 10/20; H02J 3/381; H02J 7/35; H02J 7/00302; H05B 2203/02; H02J 2300/26

(57) ABSTRACT

A Photovoltaic powered cooking system comprised of a small solar panel array 500-1,000 Watts, a charge controller for a battery capable of storing electric power and delivering it day or night for cooking using a low voltage 12-48 VDC, low power, 500 W heater configured as a hot plate or oven capable of 240° C. to boil, bake or fry food. The heater is comprised of multiple standard resistive or positive temperature coefficient heating elements or both combined to be energy efficient and can cook and then be controlled to keep food warm. No combustible fuel needed.

### PRIOR ART

Standard solar cookers are based on a solar heated closed insulated cooking pot or chamber with blackened surfaces surrounded by solar reflectors to concentrate the solar isolation to 1,000 Watts/m² (One square meter of reflector aperture), and direct light through a convection shielding window on to the blackened absorber pot or box. This concentrates the solar energy by a factor of 10 and hence these solar ovens can reach up to 180° C. (356° F.) to boil water and bake bread. The reflecting solar cookers have ratings of 80-200 Watts of power into the food, based on Solar Cookers International ASAE S580.1. Most conventional electric stoves have 4 surface burners each of about 500 to 1,000 Watts of heating if both heating elements are turned on. Current solar reflecting solar ovens are cheap, but about four of the reflecting solar ovens must be used to match the cooking power in kWh of what one PV hot plate delivers to the food cooking pot or pan. Solar ovens must be moved hourly to stay aligned with the direct beam radiation coming from the sun. Cooking is an art in these ovens, since it is difficult to regulate the temperature and cook food of different heat capacities. The reflective solar cooking devices can provide the heat needed to cook the food from 4 hours before and 4 hours after noon, When the cooking dishes are removed from the solar powered devices, they can be placed in insulating bags which will keep the food hot for several hours for evening consumption.

There are also some parabolic trough and parabolic dish solar cookers. In these cookers a pot blackened on the outside is placed at the focus of a reflecting or refracting parabolic concentrating lens, the reflectors are about one square meter of reflector aperture and concentrate about 1,000 Watts onto the pot. The pot will boil vigorously, but much of the heat is lost, because the pot cannot be easily insulated, since the solar rays must impinge on the pots blackened outer surface. Glass shields can be added to reduce heat loss, but add to the expense. The food container must be held mechanically at the focus of the concentrator, and both the concentrator and food container pot or tube must be tracked on few minute intervals to keep the suns reflected image centered on the container. This makes the system more costly, and usually requires electric motors to operate the system azimuth and or elevation trackers.

Due to significant reductions in the cost of Photovoltaic (PV) panels from $10.00 per Watt to less than $1.00 per Watt today, there is a renewed interest in using PV systems to power solar cooking. Prior art PV powered solar cooking systems have mostly used inverters to convert the photovoltaic 12-24 VDC power to 115-220 VAC then run conventional resistive “Calrod®” hot plates, Microwave ovens, induction hot plates and other 115-220 VAC cooking appliances. These conventional appliance heating elements take 1,000 to 2,000 Watts and are very inefficient, with high heat loss to the environment, due to their high operating temperatures about 800° C. (1,472° F.). Microwave ovens and induction cook stoves are very efficient, but costly. These systems have been proven to work, but need large solar PV arrays, large battery storage banks, and are expensive since they have complex power electronics such as solar battery charge controllers, DC to AC inverters, and appliance electronics all running at 115-220 VAC, require Underwriter Laboratory testing and approval to prevent electrocution and fire hazards. Many conventional appliances are UL approved; low voltage Solar Cooking Systems are not UL approved. Electric systems of less than 60 VDC are not electrocution hazards and do not need UL approval for this hazard. The low temperature, 300° C. (572° F.), hot plate eliminates the open fire hazard.

The present invention overcomes the limitations of current solar cookers. It will work well in the mornings and afternoon if the photovoltaic panels are positioned twice during the day, which can easily be done manually. With the battery, food can be cooked for breakfast before sunrise and kept warm after sundown. The PV powered solar cooking system can be made inexpensively, so savings in wood or fuel costs can pay for the system.

### BACKGROUND OF THE INVENTION

Many parts of the world have depended on wood, charcoal or kerosene/gasoline as a cooking fuel for centuries. Overpopulation is causing massive deforestation, and fuel wood gathering is taking progressively more time as the distance traveled to collect the wood increases. Most of the wood collected is used to boil water for cooking rice and beans, bread, vegetables and meat. Most homes with wood or kerosene cooking stoves have no access to electric power to run pumps and fans, so cooking pollutes the indoor air and is unhealthy for the cook and any people in the cooking area. In Haiti, the poorest country in the western hemisphere, people cut down fruit trees for firewood, instead of letting them mature and provide fruit for years to come. A solar replacement for wood as fuel wood will protect vital fruit trees, while cooking food staples for the local population. Solar energy is plentiful in most of the arid regions of the world where there are limited supplies of wood.

The present invention is a Photovoltaic (PV) solar collector of 300 to 1,000 Watts connected to a solar controller, to charge a storage battery and a 12 to 48 VDC very efficient low loss regulatable 300° C. (572° F.) heater comprised of Positive Temperature Coefficient self-regulating heaters and/or standard resistive heaters. These heater elements are formed into hot plates and small ovens. The present invention will allow PV solar power heating arrays to reach 300° C. (572° F.) and are capable of boiling water in pots to cook rice, beans, pasta etc. and with a frying pan on a hot plate fry tortillas, breads, vegetables, and meat. Placing an insulated enclosure over the hot plate heater element forms an oven that can be used for baking meals, cakes and breads. The present invention does not need any grid electricity to operate because has its own battery storage to store excess solar energy in the daytime, so it can store electricity in hazy and low light conditions for use at night and early morning.

### SUMMARY OF THE INVENTION

The invention consists of a Photovoltaic flat plate solar collector, which produces power when the sun shines on it, a controller to maximize the current delivered by the collector to the 12-to-48-volt Direct Current battery and heater system. During the day the solar electric power is used to power the heater and boil, bake, or fry food, with excess power going to charge a battery. Electricity to power the heater can be drawn from the battery at night.

A conventional “Calrod®” resistive electric stove top burner and oven elements heat the food to between 100° C. (212° F.) and 300° C. (572° F.). The heater elements glow when powered and reach 800° C. (1,472° F.). This is much higher than needed to cook the food, but greatly enhances heat transfer to reduce cooking time. With grid electricity this works fine, because a typical stove top burner of 1,000 W is only on 20% to 50% and the thermostat shuts it off for 50% to 80% of the time. So, the food sees 200 W to 500 W average cooking power. When the burner is on it draws 8.7 Amps at 115 VAC. A 12 V burner of 1,000 W would need a power cord that could carry 83 Amps, American Wire Gauge (AWG) #6 conductor. Hence a 12V 1000 W thermostatically controlled burner is impractical. Our invention is a 12V heater that delivers to 200 W to 500 W of power needed to cook food while limiting the Amps needed to less than 40 so the power cord can be AWG #12, a more reasonable size. This will allow temperatures up to 300° C. (572° F.) to boil, bake and fry foods just like conventional hot plate burner, with much lower power and much less heat loss so it can be run by a photovoltaic off grid power source. Also, since the heater does not reach the spontaneous combustion temperature of cardboard 425° C. (797° F.), simple cooking pots and pans can be insulated to reduce heat loss with cardboard, and paper mache, or high temperature foam materials.

The invented 12 VDC heater achieves the precise delivery of the power needed to cook the food in three ways, first dividing the resistive heating element into multiple individually switchable elements with a total power of 500 Watts. This limits the heater temperature to 275° C. minimizing heat loss to the environment. The second invented heater uses positive temperature coefficient heating elements to both heat and act as their own thermostat so as the food temperature approaches 275° C. PTC limit, the PTC power decreases from 500 W to 200 W to keep the food at 100° C. for boiling, 163° C. for baking and 240° C. for frying. Again, the heat loss to the environment is minimized, while supplying only the minimum cooking power needed to cook the food. The third approach combines the first two by having a PTC heater element in series with a resistive heating element so as the food approaches that 275° C. PTC limit the PTC reduces the power by limiting the current through both itself and the resistive element in series with it. Again, the heat loss to the environment is minimized, while supplying only the minimum cooking power needed to cook the food.

These energy efficient heaters allow food to be cooked with less consumption of electric power at 12 V reducing the size of the photovoltaic panel array and battery storage needed to cook the food. The present invention allows practical solar powered, battery storage, efficient heater systems to cook food wherever the sun shines.

Additional objectives, advantages and novel features of the invention will be set forth in part in the description which follows and in part will become apparent to those skilled in the art upon examination of the following. In particular, the use of photovoltaic panel which has a solar controller to maximize useful electric energy delivered from the solar panel to the battery and includes a storage battery and to power a low voltage heater capable of being configured as a hot plate burner or oven, which delivers just enough power to cook the food and reduces the cooking power as the food gets warmer while reducing the heat losses from the heating elements to their surroundings, will be included in this patent. Others may be learned by practice of the invention. The objectives and advantages of the invention may be realized and attained by means of the instrumentalities and combinations particularly pointed out in the appended claims.

### BRIEF DESCRIPTION OF DRAWINGS

FIG. 1 is a perspective view of the complete hot plate solar cooker system showing how all of the parts are connected together.

FIG. 2 is a perspective view of a Positive Temperature Coefficient (PTC) Self-regulating resistive heater element and a standard resistive heating element.

FIG. 3 is a graph of the power reduction as food temperature rises of the self-regulating hot plate heater using all Positive Temperature Coefficient elements PTC's and Positive Temperature Coefficient elements PTC's plus standard resistive heating elements in parallel and series connections.

FIG. 4 is a graph of the power consumption as food temperature reaches set point of the thermostat-regulated hot plate heater using standard resistive heating elements.

### DETAILED DESCRIPTION OF THE INVENTION

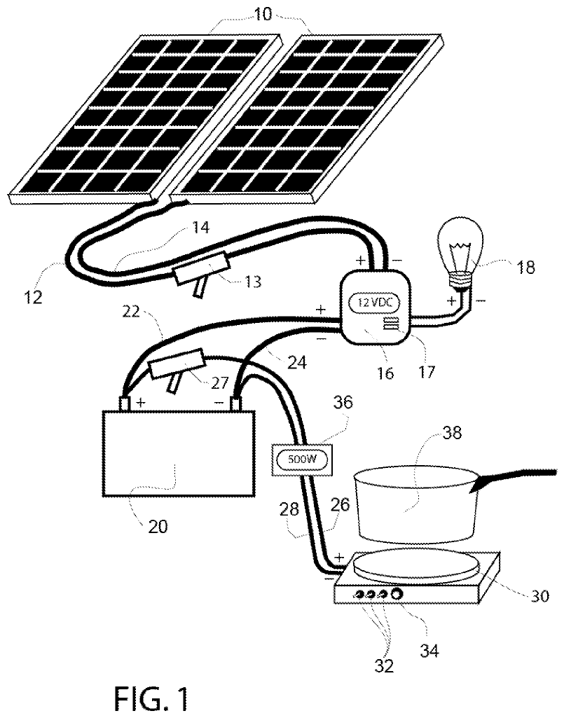

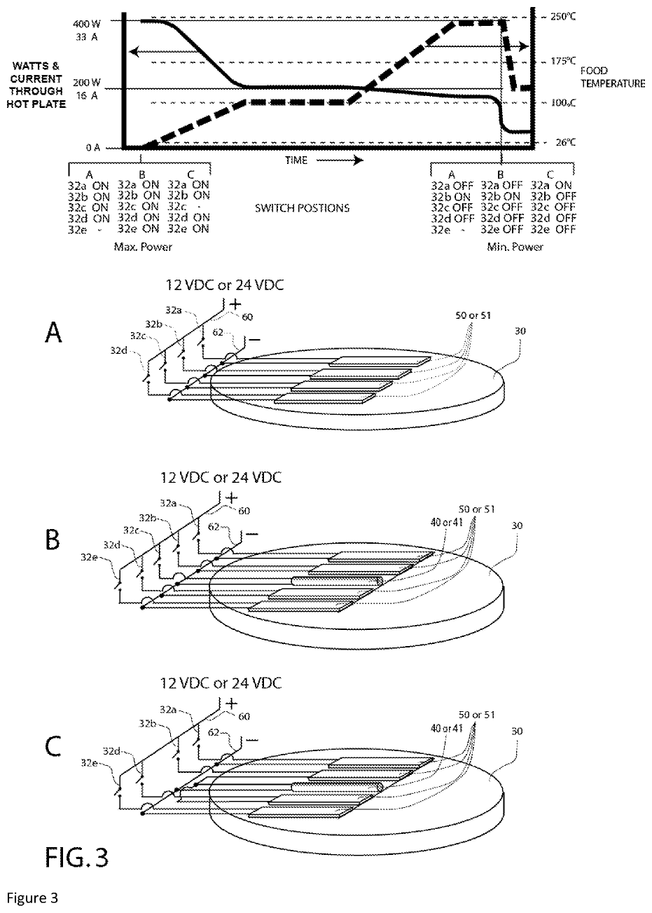

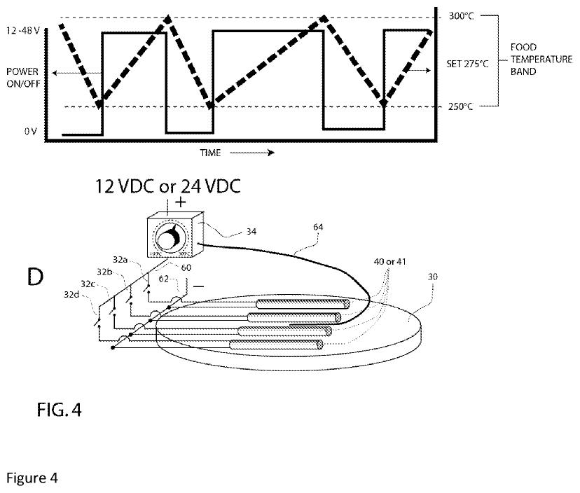

A solar cooking system (FIG. 1) consisting of a Photovoltaic (PV) solar collector array (10) capable of providing power at 12-24 volts and power of 300-1,000 Watts. The power is typically increased as battery capacity is increased. The power from the solar collectors passes through a circuit breaker (13) and is matched to the battery of 12 or 24 Volts Direct Current (VDC) by a solar charge controller (16) which has a peak power tracker to maximize the Photovoltaic Fill Factor (FF) of the PV panel array. The panel fill factor is the product of short circuit current times the short circuit voltage. By Maximum Power Point Tracking (MPPT) the current to the battery is limited to achieve maximum voltage at the PV panel for all solar insolation levels, from 400 W/m² to 1,000 W/m². The controller accomplishes this by using pulse width modulation to manage the charge current to the battery. The charge controller provides a USB port for charging cellphones and computers (17) and an output to power low voltage LED lighting (18). The charge controller also measures the battery voltage and displays a measure of the state of charge. The battery (20) can be Lead acid or Li-Ion with the ability to deliver 40 Amps at 12 VDC or 20A at 24 VDC. The battery electric storage capacity should be between 400-Watt hours (Wh) and 800 Wh. The battery is connected through a breaker (27) directly to the heating unit (30) and or through a power meter shown as (36) which displays the real time current in Amps, the maximum Amps drawn, the real time power in Watts and the peak power in Watts and the Watt hours used by the heating unit (30). The heating unit can receive power in parallel from both the photovoltaic array and the battery. The heating unit (9) converts the electric power to heat very efficiently using self-regulating Positive Temperature Coefficient (PTC) resistors and/or standard resistive heating elements which need feedback into the heating units or a load for heat removal to control temperature built into heating unit shown in FIG. 3 or a thermostat shown in FIG. 4.

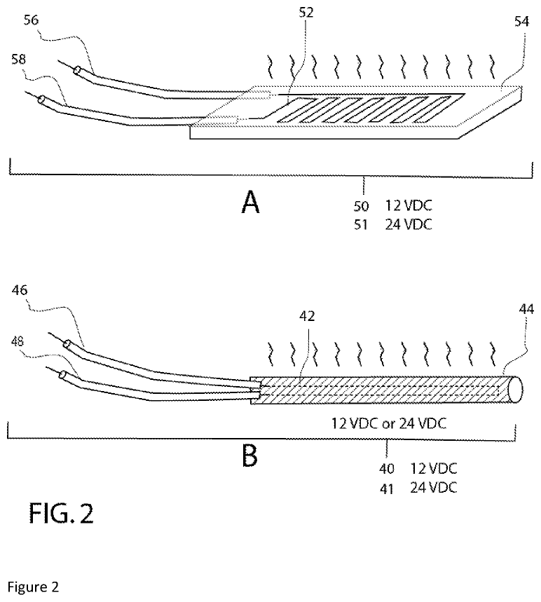

Positive Temperature coefficient heating element is shown in FIG. 2-A consists of a positive lead (56), a negative lead (58) and the heater element plate (54). The ceramic heater element (54) increase resistance as its temperature rises from room 26° C. temperature to 240° C. At 12 Volts a single heater element will approximately double its resistance from 1 Ohm to 2 Ohms from room temperature to 240° C. This means the current it draws changes from 12 Amps to 6 Amps as the temperature rises, meaning the power delivered from each element goes from 144 Watts to 72 Watts. This action self regulates the heater so it reaches its maximum temperature of 240° C. and will not go any hotter. This temperature is what is needed to boil, bake and fry foods. These PTC heater assemblies come in 12 VDC (50) and 24 VDC (51).

Standard resistive heating element is shown in FIG. 2-B. It consists of two leads (46 and 48), and a resistive heater wire (42). These resistive heater rods or plates (44) keep nearly the same resistance as their temperature rises from room 26° C. temperature to 500° C. At 12 Volts a single resistive heater element (44) will keep its 1 Ohm resistance from room temperature to 500° C. This means the current it draws stays at 12 Amps as the temperature rises, meaning the power delivered from each element (44) is 144 Watts. The heater element (44) will be able to reach a temperature close to 500° C. (932° F.). This temperature is above what is needed to boil, bake and fry foods. Hence these elements (40 & 41) can be mixed with PTC heater elements (50 & 51), and be switched and or thermostatically controlled in the same ways. These resistive heater assemblies come in 12 VDC (40) and 24 VDC (41).

The power of the heater array FIG. 3 is determined by how many elements are attached to a round plate to form a hot plate (30) or to a rectangular plate to form an oven heater not shown which use similar elements as those used in plate (30) or held by a frame in air for the oven. Typically, 2 to 6 elements are used, four and five are shown in FIG. 3 since the wiring to the hot plate limits the available current to the heater assembly to 40 Amps at 12 Volts for AWG #12 wire (60 & 62) or 20 Amps at 24 Volts for AWG #16 wire (60 & 62). Individual heating elements can be switched on or off via switches (32a, 32b, 32c, 32d & 32e).

The heater assembly typical wiring diagrams FIG. 3 are needed to both limit current in Amps and cooking power to match availability of solar power or stored battery power. The manually switched four Positive Temperature Coefficient elements (32a, 32b, 32c &32d) shown in FIG. 3-A is the simplest with the cook using full power to cook the food fast, then turn off elements (32a, 32c & 32d) to simmer, then all but one element (32b) to keep food warm for serving long after sundown.

The curves in FIG. 3 show how the power to the hot plate self-regulating elements is going down from 400 W to 200 W as the food sitting on the hot plate warms up, first to boiling 100° C. (212° F.) then to baking 175° C. (347° F.) then to frying 250° C. (482° F.). Then by turning off all switches but (32b) the power to the hot plate can be reduced to about 100 W to keep food on the hot plate warm for serving later. The switches FIG. 3-A (33a, 32b, 32c & 32d) allow the user to precisely regulate the food temperature and time at temperature. FIG. 3-A shows all PTC elements 12 VDC (50) or 24 VDC (51) in parallel and all individually switched (33a, 32b, 32c & 32d) on hot plate (30). The PTC element power can also be switched in parallel pairs to reduce power or all turned on and off with one switch and forgo the ability to reduce the power after food is cooked.

FIG. 3-B shows four Positive Temperature Coefficient elements 12 VDC (50) or 24 VDC (51) and one resistive heating elements 12 VDC (40) or 24 VDC (41) all in parallel switched (32a, 32b, 32c, 32d & 32e) on hot plate (30). This allows for the power to be regulated by the cook and provides maximum power to the resistive element. This configuration can reach 300° C. (572° F.). Any combination of standard resistive and PTC elements can be used as long as they fit on a heater plate or frame of some kind and don't exceed the 40 Amp. power draw requirements.

FIG. 3-C shows four Positive Temperature Coefficient elements 12 VDC (50) or 24 VDC (51) and one resistive heating elements 12 VDC (40) or 24 VDC (41) with the standard resistive element in series with two Positive Temperature Coefficient elements switched (32a, 32b, 32d & 32e) on hot plate (30). The standard resistive element or elements can be put in series with one or more PTC elements to achieve the desired power in the standard resistive element or elements when the current though the PTC elements decreases with increasing temperature, thus the PTC elements act as a temperature controller for the standard resistive element by limiting the current to it or them. This configuration will limit below 300° C. (572° F.). Any combination of standard resistive and PTC elements can be used as long as they fit on a heater plate or frame of some kind and don't exceed the power draw requirements.

The power of the heater array FIG. 4 comprised of standard resistive heating elements is determined by how many elements are attached to a round plate to form a hot plate (30) or to a rectangular plate to form an oven heater (30) or frame of some kind for an air oven. Typically, 2 to 6 elements are used, four standard resistive elements are shown in FIG. 4 since the wiring to the hot plate limits the available current to the heater assembly to 40 Amps at 12 Volts for AWG #12 wire (60 & 62) or 20 Amps at 24 Volts for AWG #16 wire (60 & 62). Individual 12 V heating elements can be switched on or off via switches (32a, 32b, 32c & 32d).

The heater assembly and thermostat is needed to both limit current in Amps and cooking power to match availability of solar power or stored battery power is shown in FIG. 4. The computer thermostat (34) could automatically switch 4 elements (32a, 32b, 32c & 32d) array again using full power to cook the food fast, then limit current and hence power using a solid-state switch in each of the elements (32a, 32b, 32c & 32d) individually or all at once using (34) Pulse Width Modulation (PWM) with full pulse width cook fast then shorter pulses to simmer, to keep food warm for serving later in the day.

The graph in FIG. 4 show how the power to the hot plate thermostat regulated elements is going from 400 W to 200 W as the food sitting on the hot plate is kept near the set point of 275° C. The on versus off time of the elements pulse width is controlled by the thermostat. More food on the hot plate means more on time and on average higher power or more Wh to cook the food. Then by turning off all switches but (32b) the power to the hot plate can be reduced to about 100 W to keep food on the hot plate warm for serving later. The switches (32a, 32b, 32c & 32d) allow the user to precisely regulate the food temperature and time at temperature. FIG. 4-D shows all standard resistive elements 12 VDC (40) or 24 VDC (41) with a thermostat and all switched (32a, 32b, 32c & 32d) on hot plate (30).

The hot plates described above have two major advantages, they limit the temperature to 300° C. (572° F.) so hot plate heat loss to surroundings is minimized and cardboard will not catch fire since there is no open flame. Corrugated cardboard has an ignition temperature of about 425° C. (797° F.) hence simple corrugated box material and paper mSche, composed of newspaper and a flower/water mixture can be added to the cooking pots and cover unused areas on the hot plate without the risk of fire. High temperature foam materials can also be used if their melting point is above 350° C. (662° F.). This type of inexpensive readily available insulation can dramatically reduce the energy needed to cook the food, making the solar hot plate system much more efficient.

1. An all low voltage direct current solar Photovoltaic and battery powered cooking system comprised of: a Photovoltaic low voltage power panel array; a battery charge controller with photovoltaic panel maximum power point tracking and pulse width modulation to prevent battery over charging, a USB port for charging phones and computers, a power output for low voltage direct current lighting; a battery capable of storing excess electric power generated during the day for cooking at night; a low voltage, direct current, high efficiency heater assembly configured as a hot plate or oven capable of about 300° C. (572° F.) to boil, bake or fry food, that is powered in parallel from the photovoltaic panel and the battery.

2. A solar cooking system according claim 1 using lead acid battery chemistry for electric storage.

3. A solar cooking system according claim 1 using advanced lithium-ion battery chemistry for electric storage.

4. A solar cooking system according claim 1 that can be expanded to support more cooks by using more solar panels, a bigger battery and multiple cooking heater assemblies.

5. A solar cooking system according claim 1 that can be expanded to support more cooks by using more solar panels and a bigger battery in parallel feeding a DC to AC inverter to power multiple AC cooking appliances.

6. A solar cooking system according claim 1 that allows cooking utensils to use thermal insulation such as cardboard and or paper mâché made of flour, water and newspaper, polymer foams or other similar insulation materials with self-ignition points greater than 425° C. (797° F.).

7. A low voltage, direct current, high efficiency heater assembly for cooking food as a hot plate or oven comprised of; multiple low voltage 12-24 VDC positive temperature coefficient self-regulating heater elements that decrease power by increasing resistance as their temperatures rise from room temperature to 300° C. food cooking temperatures; the heater elements are arranged in series or parallel; the heater elements can be individually controlled where each element or series elements can be switched on or off manually or automatically via a computer to reduce cooking power to keep food warm after cooking.

8. A low voltage, direct current, high efficiency heater assembly for cooking food as a hot plate or oven comprised of; both positive temperature coefficient and standard resistive heating elements connected in series so that the positive temperature coefficient heater elements control the current to the standard resistive heating elements to maintain cooking temperature around 300° C. where the power delivered to the hot plate can be regulated by switching on or off paired elements for cooking and then keeping cooked food warm.

9. A low voltage, direct current, high efficiency heater assembly for cooking food as a hot plate or oven comprised of; several standard resistive heating elements that must be controlled to maintain cooking temperature around 260° C. to 500° C. where the power delivered to the hot plate can be regulated by a temperature sensing controller by pulse width modulation of the DC for all or only switched-on elements for cooking and then keeping cooked food warm.
